(19) United States
(12) Patent Application Publication
(10) Pub. No.: US 2025/0254533 A1
(43) Pub. Date: Aug. 7, 2025

(54) RADIO FREQUENCY INTERFERENCE REDUCTION SYSTEMS AND METHODS

(71) Applicant: Aviat U.S., Inc., Austin, TX (US)

(72) Inventor: Robert Vilhar, Radomlje (SI)

(21) Appl. No.: 18/432,622

(22) Filed: Feb. 5, 2024

(51) Int. Cl. H04W 24/02; H04B 17/345

(52) U.S. Cl. CPC H04W 24/02; H04B 17/345

(57) ABSTRACT

Provided are techniques that include receiving, from a wireless device, a registration request; sending, to the device, a first set of device transmission characteristics; receiving, from a terminal system, an interference report identifying an interfering wireless device, where the terminal system includes: an antenna system including: a first and second antenna systems adapted to receive wireless signals; and a signal processing unit (SPU) adapted to: receive a first wireless signal received by the first antenna; receive a second wireless signal received by the second antenna; determine, based on the first and second wireless signals, an identity of the interfering wireless device and generate the interference report; determining that the interfering device corresponds to the wireless device; determining a second set of device transmission characteristics to reduce interference of the first wireless signal; and sending, to the wireless device, the second set of device transmission characteristics.

### FIELD

Embodiments relate generally to reduction of signal interference and more particularly to techniques for identifying and addressing sources of interference in radio spectrum communications.

### BACKGROUND

Wireless communication refers to the transmission of data or information between devices without the need for physical cables or wires. Wireless communication is facilitated using electromagnetic waves, such as radio frequency (RF) signals, to carry information between devices, enabling the exchange of data over short or long distances. RF is a subset of electromagnetic frequencies commonly used in wireless communication. RF encompasses a range of frequencies, typically from 3 kHz to 300 GHz, with applications in various wireless technologies, such as radio broadcasting, Wi-Fi, Bluetooth, and cellular networks. RF signals are modulated to encode information and then transmitted wirelessly to communicate between devices. Wireless interference occurs when unwanted signals disrupt the normal operation of wireless communication transmission, and can be caused by various sources, such as other electronic devices, environmental factors, or competing wireless networks operating in the same frequency range. Interference can lead to degraded signal quality, reduced data transfer rates, or communication failures.

### SUMMARY

Wireless systems operators often employ various techniques to enhance the performance and reliability of wireless communications. For example, mitigation strategies, such as frequency planning, signal shielding, and error correction techniques, are employed to minimize the impact of interference and maintain the reliability of wireless communication systems. As wireless communication systems continue to evolve, including the introduction of new standards and devices, new challenges for maintaining and enhancing the performance and reliability of wireless communications are created.

In wireless communication, it is common for wireless communications by certain devices to interfere with wireless communications by other devices. For example, devices that operate on similar wireless channels (e.g., having a similar frequency, power level, or the like) may generate signals that interfere with one another. In many instances, communications are controlled (or “regulated”) to reduce interference. For example, point-to-point (P2P) type wireless systems are limited to operating in licensed bands and are regulated to provide high levels of inter-system interference protection.

P2P wireless communication typically employs a direct link between two specific points or locations to transfer data therebetween. In a P2P wireless setup, there are traditionally two distinct devices, each equipped with transmitters and receivers, allowing them to communicate exclusively with each other. This provides for wireless transmission of data between the two “points” where the devices are located and is commonly used for connecting two physically separate network nodes, such as nodes at geographically separate buildings, offices, or remote locations. P2P systems can be advantageous because they provide a direct connection. For example, P2P wireless devices typically establish a direct communication link between two endpoints without the need for intermediary network infrastructure like routers or switches. Further, P2P systems often provide highly focused communication. For example, P2P wireless devices often use directional antennas to focus their signal in a specific direction, optimizing the transmission of data between the two points and minimizing interference from other sources. P2P systems typically provide long range connectivity. For example, P2P wireless devices can be designed for long-distance communication, making them useful for applications such as connecting buildings, providing internet connectivity in rural areas, or establishing communication links between remote facilities. P2P wireless devices can be designed to support high data transfer rates, making them suitable for applications that require substantial bandwidth, such as point-to-point backhaul connections for wireless networks, and can be useful in a variety of applications, across various industries, such as telecommunications, industrial automation, and rural connectivity projects.

In practice, the most common sources of interference for P2P links are other geographically close P2P systems operating on the same channel or collocated P2P systems operating on an adjacent channel. In some frequency bands, radars and ground/satellite transmitters can also generate interference that is received at the P2P receiver. In all practical cases the interference sources are of a relatively constant level and of a known and fixed location. As a result, the interfering systems are known, or can otherwise be easily identified, and the interference can often be resolved by varying the location or transmission characteristics of the systems.

In some instances, however, interference is introduced from a variety of relatively “unknown” or otherwise difficult to identify sources, such as wireless local area network (WLAN) access points (APs), or the like. As additional technologies are developed and more wireless devices are deployed, the number and types of interferences sources will continue to increase. For example, in 2020 the FCC approved the use of a 6 GHz FXS band for Wi-Fi networks and permitted WiFi6E devices (6E=6 GHz Extended) to operate in the 5925-7125 MHz frequency band under constraints given by the FCC RO 20-51A1. Although there may be limitations on the use of the WiFi6E devices, the nature of WLAN networks is different than that of P2P networks, which may introduce additional opportunities for interference between P2P and WLAN devices, including WiFi6E devices.

For example, WLAN systems of 802.11 type are generally designed to operate in a highly unregulated and interference limited environment, and the service quality requirements for the WLAN networks are orders of magnitude lower than what is expected from P2P networks. P2P systems are Frequency Division Duplex (FDD), meaning the transmitter and receiver use channels that are separated in frequency, while WLAN systems are Time Division Duplex (TDD), meaning the transmitter and receiver share the same frequency channel at different times, which can make coexistence of P2P and WLAN device difficult and interference prone. WLAN is built on a Carrier Sense Multiple Access (CSMA) channel access mechanism, meaning that the WLAN transmitter (TX) does not start its transmission on a channel where its receiver (RX) senses the presence of other signals. Accordingly, WLAN SCMA methods may enable WiFi6E devices to avoid the channels where a P2P system transmits (based on detected transmission by its WLAN receiver) but may not provide for detection of the channel where a nearby P2P receiver operates, creating increased opportunities for WLAN devices generating signals that interfere with P2P receivers. In many instances, wireless access points (APs) (e.g., even at idle, with no devices connected) transmit a beacon signal (e.g., at 0.5 ms duration every 100 ms using maximum power), so even when APs are idle there are opportunities for APs generating P2P interference. As a result, WLAN devices, such as WiFi6E devices, may create interference for P2P receivers, and these instances will likely increase as the number of devices increase over time.

Provided are improved systems and methods for reducing interference between wireless communication systems, such as P2P devices and WLAN devices. Certain embodiments include providing for registration of APs and P2P devices with a central coordinator (CC) (e.g., an Automated Frequency Coordination (AFC) system) that monitors and regulates transmission characteristics for the devices. A P2P device can report interference by a given AP device and the CC can, in turn, instruct modification of the transmission characteristics of the offending AP device to resolve the interference. In some embodiments, the AP device provides registration information that includes a unique identifier of the AP device (e.g., among other characteristics of the AP device), the CC provides to the AP device a set of device transmission characteristics including one or more RF channels available for transmission by the AP device, and the AP device operates according to the set of device transmission characteristics, including transmitting on the one or more RF channels indicated. A P2P device checks for signal interference by an AP device and, in response to identifying interference, inspects the signal to identify an offending AP device generating the interfering signal, and reports the interference and the offending AP device to the CC. In turn, the CC generates an updated set of device transmission characteristics for the offending AP device that are intended to reduce or eliminate the interference (e.g., excluding one or more wireless channels that the P2P is using or otherwise suspected of causing the interference, such as the channel the AP is currently using) and provides the updated set of device transmission characteristics to the offending AP device. The offending AP device may, in response, operate according to the modified set of device transmission characteristics (e.g., including not transmitting on the excluded wireless RF channel(s)).

In some embodiments, the unique identifier of an AP device is a basic service set identifier (BSSID) of the wireless device, the media access control (MAC) address of the wireless device (e.g., a MAC address of a network interface card (NIC) of the wireless device, which may be), or the like. In certain embodiments, the P2P employs an identity decoder to identify when certain AP devices are transmitting and correlates the times of the interfering transmissions with times of interference to determine the specific AP that generated the interfering signal. In such an embodiment, the CC may then match or otherwise correlate the identity of the AP to an identity of an AP device provided at the AP device's registration, to identify the AP device to be targeted for update. In some embodiments, the P2P employs a first antenna (e.g., a directional antenna) to obtain a first signal, a second antenna (e.g., a wide antenna) to obtain a second signal, and a signal processing unit (SPU), where a first path of the SPU is employed to assess the first and second signals to determine times of signal interference, a second path of the SPU is employed to determine times and identities of AP devices transmitting, and the SPU correlates a time of signal interference with a corresponding time of transmission by an AP device to identify an offending AP device.

Provided in some embodiments is a radio communication system including: a point-to-point terminal system including: an antenna system including: a point-to-point antenna adapted to receive point-to-point radio frequency (RF) signals from one or more point-to-point wireless devices; and a wireless antenna adapted to receive wireless RF signals from one or more wireless devices; a point-to-point receiver adapted to process a point-to-point RF signal received by way of the point-to-point antenna; and a signal processing unit (SPU) adapted to: receive the point-to-point RF signal received by way of the point-to-point antenna; receive a wireless RF signal received by way of the wireless antenna; determine, based on the point-to-point RF signal and the wireless RF signal, an identity of a wireless device generating interference of the point-to-point RF signal; and send, to an automated frequency coordination (AFC) system, an interference report including an indication of the identity of the wireless device generating interference to the point-to-point RF signal; and the AFC system communicatively coupled to the one or more wireless devices and the SPU, the AFC system adapted to: receive, from the wireless device, a registration request including a unique identifier of the wireless device; send, to the wireless device in response to receiving the registration request from the wireless device, a set of device transmission characteristics including a set of one or more wireless RF channels available for transmission by the wireless device; receive, from the SPU, the interference report; determine whether the identity of a wireless device generating interference of the point-to-point RF signal corresponds to the unique identifier of the wireless device; determine, in response to determining that the identity of the wireless device generating interference of the point-to-point RF signal corresponds to the unique identifier of the wireless device, an updated set of one or more wireless RF channels available for transmission by the wireless device; and send, to the wireless device, an updated set of device transmission characteristics including the updated set of one or more wireless RF channels available for transmission by the wireless device.

In some embodiments, the updated set of one or more wireless RF channels available for transmission by the wireless device are adapted to cause the wireless device to employ wireless transmission on the one or more wireless RF channels available for transmission by the wireless device to reduce interference to the point-to-point RF signal. In certain embodiments, the point-to-point antenna includes a directional antenna. In some embodiments, the wireless antenna includes an omnidirectional antenna. In certain embodiments, the wireless device includes an access point (AP). In some embodiments, the unique identifier of the wireless device includes a media access control (MAC) address of the wireless device wireless NIC. In certain embodiments, the identity of the wireless device includes a basic service set identifier (BSSID) of the wireless device or a media access control (MAC) address of the wireless device. In some embodiments, the device transmission characteristics include frequency, transmission power, or bandwidth available for transmission by the wireless device on the wireless RF channels. In certain embodiments, the AFC system is further adapted to: determine that the wireless signal received by way of the wireless antenna is transmitted on a given wireless RF channel, where the updated set of one or more wireless RF channels available for transmission by the wireless device excludes the given wireless RF channel. In some embodiments, the AFC system is further adapted to: determine that the point-to-point RF signal includes a given wireless RF channel, where the updated set of one or more wireless RF channels available for transmission by the wireless device excludes the given wireless RF channel. In certain embodiments, the SPU includes: a first signal path adapted to identify signal interference at a given time; and a second signal path adapted to determine an identity of a wireless device transmitting at a time corresponding to the given time, where the identity of the wireless device generating interference to the point-to-point RF signal corresponds to the identity of the wireless device transmitting at a time corresponding to the given time. In some embodiments, the first signal path includes: a down converter adapted to receive the P2P RX signal and the wireless RF signal and output a down-converted signal; and a detection engine adapted to receive the down-converted signal and output an interference indicator including an identification of signal interference at a given time; where the second signal path includes: a BSSID identifier adapted to receive the wireless RF signal and output a BSSID mapping identifying wireless devices and associated times of transmission by the wireless devices; and a central processing unit adapted to: receive the interference indicator and the BSSID mapping; determine, based on the interference indicator and the BSSID mapping, an identifier associated with a wireless device having a time of transmission that corresponds to the given time; and send, to the AFC system, an interference report including the identifier, where the indication of the identity of the wireless device generating interference to the point-to-point RF signal includes the identifier, and the interference report including an indication of the identity of the wireless device generating interference to the point-to-point RF signal includes the interference report including the identifier.

Provided in some embodiments is a radio communication system including: a terminal system including: an antenna system including: a first antenna adapted to receive wireless signals; and a second antenna adapted to receive wireless signals; and a signal processing unit (SPU) adapted to: receive a first wireless signal received by way of the first antenna; receive a second wireless signal received by way of the second antenna; determine, based on the first wireless signal and the second wireless signal, an identity of an interfering wireless device generating interference to the first wireless signal; and generate an interference report identifying the interfering wireless device; a coordination system adapted to: receive, from a wireless device, a registration request identifying the wireless device; send, to the wireless device in response to receiving the registration request, a first set of device transmission characteristics; receive the interference report; determine that the interfering wireless device corresponds to the wireless device; determine, in response to determining that the interfering wireless device corresponds to the wireless device, a second set of device transmission characteristics adapted to reduce interference of the first wireless signal; and send, to the wireless device, the second set of device transmission characteristics.

In some embodiments, the second set of device transmission characteristics excludes a channel used to transmit the first wireless signal. In certain embodiments, the first antenna includes a directional antenna. In some embodiments, the second antenna includes an omnidirectional antenna. In certain embodiments, the wireless device includes an access point (AP). In some embodiments, the wireless device is associated with a unique identifier, the interference report includes the unique identifier, the registration request includes the unique identifier, and determining that the interfering wireless device corresponds to the wireless device includes correlating the unique identifier of the interference report with the unique identifier of the registration request. In some embodiments, the unique identifier of the wireless device includes a media access control (MAC) address of the wireless device.

Provided in some embodiments is method including: receiving, from a wireless device, a registration request identifying the wireless device; sending, to the wireless device in response to receiving the registration request, a first set of device transmission characteristics; receiving, from a terminal system, an interference report identifying an interfering wireless device, where the terminal system includes: an antenna system including: a first antenna adapted to receive wireless signals; and a second antenna adapted to receive wireless signals; and a signal processing unit (SPU) adapted to: receive a first wireless signal received by way of the first antenna; receive a second wireless signal received by way of the second antenna; determine, based on the first wireless signal and the second wireless signal, an identity of an interfering wireless device generating interference to the first wireless signal; and generate the interference report identifying the interfering wireless device; determining that the interfering wireless device corresponds to the wireless device; determining, in response to determining that the interfering wireless device corresponds to the wireless device, a second set of device transmission characteristics adapted to reduce interference of the first wireless signal; and sending, to the wireless device, the second set of device transmission characteristics.

Provided in some embodiments is a non-transitory computer readable storage medium including program instructions stored thereon that are executable by a processor to cause the following operations: receiving, from a wireless device, a registration request identifying the wireless device; sending, to the wireless device in response to receiving the registration request, a first set of device transmission characteristics; receiving, from a terminal system, an interference report identifying an interfering wireless device, where the terminal system includes: an antenna system including: a first antenna adapted to receive wireless signals; and a second antenna adapted to receive wireless signals; and a signal processing unit (SPU) adapted to: receive a first wireless signal received by way of the first antenna; receive a second wireless signal received by way of the second antenna; determine, based on the first wireless signal and the second wireless signal, an identity of an interfering wireless device generating interference to the first wireless signal; and generate the interference report identifying the interfering wireless device; determining that the interfering wireless device corresponds to the wireless device; determining, in response to determining that the interfering wireless device corresponds to the wireless device, a second set of device transmission characteristics adapted to reduce interference of the first wireless signal; and sending, to the wireless device, the second set of device transmission characteristics.

### BRIEF DESCRIPTION OF THE DRAWINGS

FIG. 1 is diagram that illustrates a communication environment in accordance with one or more embodiments.

FIG. 2 is a diagram that illustrates a point-to-point (P2P) terminal system in accordance with one or more embodiments.

FIG. 3 is a flowchart diagram that illustrates a method of coordinating operations of communication devices in accordance with one or more embodiments.

FIG. 4 is a flowchart diagram that illustrates a method of monitoring communications for interference in accordance with one or more embodiments.

FIG. 5 is a diagram that illustrates an example computer system in accordance with one or more embodiments.

While this disclosure is susceptible to various modifications and alternative forms, specific example embodiments are shown and described. The drawings may not be to scale. The drawings and the detailed description are not intended to limit the disclosure to the form disclosed, but are intended to disclose modifications, equivalents, and alternatives falling within the spirit and scope of the present disclosure as defined by the claims.

### DETAILED DESCRIPTION

Described are embodiments for reducing interference between wireless communication systems, such as P2P devices and WLAN devices. Certain embodiments include providing for registration of APs and P2P devices with a central coordinator (CC) (e.g., an Automated Frequency Coordination (AFC) system) that monitors and regulates transmission characteristics for the devices. A P2P device can report interference by a given AP device and the CC can, in turn, instruct modification of the transmission characteristics of the offending AP device to resolve the interference. In some embodiments, the AP device provides registration information that includes a unique identifier of the AP device (e.g., among other characteristics of the AP device), the CC provides to the AP device a set of device transmission characteristics including one or more RF channels available for transmission by the AP device, and the AP device operates according to the set of device transmission characteristics, including transmitting on the one or more RF channels indicated. A P2P device checks for signal interference by an AP device and, in response to identifying interference, inspects the signal to identify an offending AP device generating the interfering signal, and reports the interference and the offending AP device to the CC. In turn, the CC generates an updated set of device transmission characteristics for the offending AP device that are intended to reduce or eliminate the interference (e.g., excluding one or more wireless channels that the P2P is using or otherwise suspected of causing the interference, such as the channel the AP is currently using) and provides the updated set of device transmission characteristics to the offending AP device. The offending AP device may, in response, operate according to the modified set of device transmission characteristics (e.g., including not transmitting on the excluded wireless RF channel(s)).

In some embodiments, the unique identifier of an AP device is a basic service set identifier (BSSID) of the wireless device, the media access control (MAC) address of the wireless device (e.g., a MAC address of a network interface card (NIC) of the wireless device, which may be), or the like. In certain embodiments, the P2P employs an identity decoder to identify when certain AP devices are transmitting and correlates the times of the interfering transmissions with times of interference to determine the specific AP that generated the interfering signal. In such an embodiment, the CC may then match or otherwise correlate the identity of the AP to an identity of an AP device provided at the AP device's registration, to identify the AP device to be targeted for update. In some embodiments, the P2P employs a first antenna (e.g., a directional antenna) to obtain a first signal, a second antenna (e.g., a wide beamwidth antenna) to obtain a second signal, and a signal processing unit (SPU), where a first path of the SPU is employed to assess the first and second signals to determine times of signal interference, a second path of the SPU is employed to determine times and identities of AP devices transmitting, and the SPU correlates a time of signal interference with a corresponding time of transmission by an AP device to identify an offending AP device.

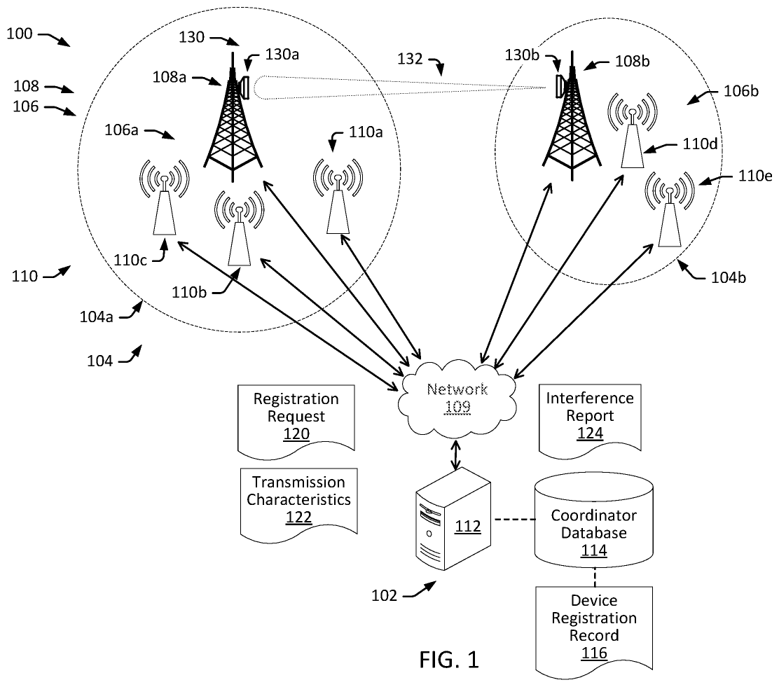

FIG. 1 is a diagram that illustrates a communication environment (“environment”) 100 in accordance with one or more embodiments. Although certain embodiments are described in the context of point-to-point (P2P) networks and access point (AP) type wireless devices for the purpose of illustration, embodiments may be employed in any suitable context, such as other types of wireless communication systems employing suitable transmitting and receiving wireless devices.

In the illustrated embodiment, environment 100 includes a coordination system (or “coordinator”) 102 and communication regions 104 (e.g., communications regions 104a and 104b). Each of the communication regions 104 includes a respective set of wireless devices 106 (e.g., wireless devices 106a and 106b), including a point-to-point (P2P) terminal system 108 (e.g., P2P terminal system 108a and 108b) and one or more access points (APs) 110 (e.g., APs 110a-110c). The wireless devices 106 (e.g., including terminal systems 108 and AP 110) are communicatively coupled to the coordinator 102 by way of a communication network (“network”) 109.

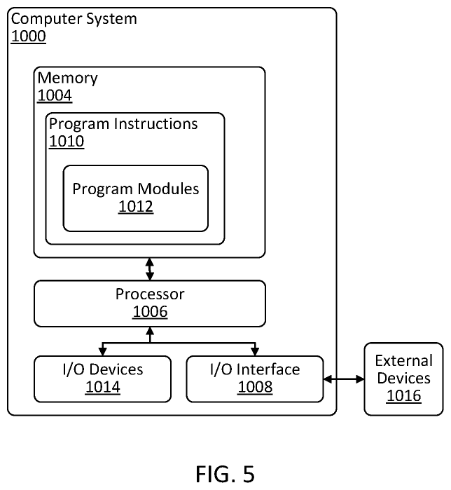

In some embodiments, coordination system (or “coordinator”) 102 is operable to provide for coordination of transmissions by some or all of the wireless devices 106 in one or more communication regions 104. For example, as discussed here, coordinator 102 may be an Automated Frequency Coordination (AFC) system (e.g., including a server 112 and database 114) that provides for registration of wireless devices 106 (e.g., including receiving registration requests 120 from APs 110 and terminal systems 108, and providing registered APs 110 with associated sets of transmission characteristics 122, such as lists of approved channels for transmission, that define how the registered APs 110 can communicate), monitoring for interference experienced by one or more wireless devices 106 (e.g., including receiving interference reports 124 from terminal systems 108 identifying APs 110 generating interference with P2P communications of the terminal systems 108), and regulating transmissions to resolve the interference (e.g., including providing interfering APs 110 with associated sets of updated transmission characteristics 122, such as an updated lists of approved channels for transmission, that define how the registered APs 110 can communicate to reduce or eliminate interference). In some embodiments, the coordinator maintains a record of registrations of wireless devices for use in assessing and regulating operations thereof. For example, coordinator 102 may include a server 112 and coordinator database 114 storing a device registration record 116. In some embodiments, the server 112 generates or updates the device registration record 116 based on registration request 120 and associated transmission characteristics 122. For example, upon receiving a registration request 120 from a given AP 110, including a corresponding set of characteristics of the AP 110, the server 112 may determine an appropriate set of transmission characteristics 122 (e.g., a list of approved channels for transmission, that define how the AP 110 can communicate), send the set of transmission characteristics 122 to the AP 110, and generate or update a corresponding entry in device registration record 116 (for the AP 110) to reflect the set of characteristics of the wireless device 110 and the current set of transmission characteristics 122. As another example, upon receiving a registration request 120 from a given terminal system 108, including a corresponding set of characteristics of the terminal system 108, such location and transmission channels used, the server 112 may generate or update a corresponding entry in device registration record 116 (for the terminal system 108) to reflect the set of characteristics of the terminal system 108. The server 112 may, for example, update the device registration record 116 as characteristics are updated over time. In some embodiments, the coordinator 102 is an AFC system that maintains a registered database of spectrum bands in use by various types of RF devices in a particular area, such as for Wi-Fi APs that operate in the 6 gigahertz (GHz) band (e.g., the 5.925-7.125 GHz range). As described, such an AFC system may, for example, monitor interference reports and dictate transmission characteristics of APs, such as channels that the AP can use. In some embodiments, coordinator 102 includes a computer system, which may be the same or similar to computer system 1000 described with regard to at least FIG. 5.

In some embodiments, a communication region 104 includes a geographic region that includes different types of wireless devices 106, such as a terminal systems 108 and one or more APs 110. For example, in the illustrated embodiment, the first communications region 104a includes a first set of wireless devices 106a that includes a first terminal system 108a and a first set of APs 110, including APs 110a, 110b and 110c, and the second communications region 104b includes a second set of wireless devices 106b that includes a second terminal system 108b and a second set of APs 110, including APs 110d and 110c. A communications region 104 may include a bounded geographic region that includes the area including the associated wireless devices 106. In some embodiments, a communications region 104 is defined by a radius (R) extending a given distance from the associated terminal system 108 and includes wireless devices 106 that fall within the radius (R).

In some embodiments, a wireless device 106 includes a communication device that is operable to communicate without the use of physical cables or wires. For example, wireless devices 106 may each be capable of communicating with each other, the coordinator, or other wireless devices wireless using electromagnetic waves, such as radio frequency (RF) signals, to carry information between devices. As described, the wireless devices 106 may include one or more PSP wireless devices, such as P2P terminal systems 108, and one or more wireless AP devices 110. In some embodiments, a wireless device 106 includes a computer system, which may be the same or similar to computer system 1000 described with regard to at least FIG. 5.

In some embodiments, a point-to-point (P2P) terminal system 108 is a wireless communication device that is operable to establish wireless communication with another wireless communication device, such as another P2P terminal system. For example, each of P2P terminal systems 108a and 108b may include a respective wireless device that is operable to establish a direct wireless link with the other, to provide direct data transmission therebetween. In some instances, a P2P terminal system 108 includes a point-to-point (P2P) antenna 130 that includes a directional antenna that focuses the transmitted signal in a specific direction to enhance the efficiency of the point-to-point link with a complementary P2P terminal system. For example, each of P2P terminal systems 108a and 108b may include a directional P2P antenna 130 (e.g., antennas 130a and 130b) that focuses (or “aims”) transmitted RF signals to the complementary directional P2P antenna 130 of the other terminal systems 108b or 108a, to enhance the efficiency of the point-to-point link and data transfer between the antennas (e.g., as illustrated by the signal beam extending from P2P antenna 130b to P2P antenna 130a). Such a narrowly focused directional beam may enhance the quality of the signal received at the receiving antenna, and limit interference to other nearby antennas. The P2P antenna 130 may be employed to transmit signals, as well as receive signals, and may be referred to as a transmitter (TX) or a receiver (RX) in the associated context. In the context of receiving signals, such a directional antenna may be designed to focus their reception in a specific direction, for example, concentrating their gain in a narrow beam, allowing for increased signal strength from the direction of an intended source and potentially rejecting signals from other directions. During transmission operation, a P2P terminal system 108 may modulate digital information into RF signals for transmission. During a receive operation, a P2P terminal system 108 may demodulate incoming RF signals to recover the original data.

A P2P terminal system 108 may operate in licensed or unlicensed frequency bands, depending on regulatory restrictions and requirements. Unlicensed bands, such as those used by Wi-Fi, can provide more flexibility but may be subject to interference. Licensed bands can span a wide range of frequencies, including microwave and millimeter-wave frequencies. These relatively high frequency bands often support higher data rates and are suitable for long-distance point-to-point links. Licensed bands may offer higher reliability and interference protection compared to unlicensed bands. They are suitable for applications where consistent performance and data throughput are critical. Licensed P2P bands are, for example, often employed for backhaul connections in cellular networks, connecting base stations to the core network infrastructure. Microwave bands, such as those around 6 GHz, 11 GHz, 18 GHz, 23 GHz, and 38 GHz, may be employed for licensed point-to-point links. These bands may provide high capacity and may be suitable for backhaul connections in telecommunications networks. Millimeter-wave bands, including those around 60 GHz and 80 GHz, and may be employed for licensed P2P links, especially in applications requiring very high data rates, such as 5G backhaul. Licensed spectrum may be allocated and regulated, for example, by the Federal Communications Commission (FCC) in the United States, or by the European Telecommunications Standards Institute (ETSI) in Europe. In some embodiments, a P2P terminal system 108 includes a computer system, which may be the same or similar to computer system 1000 described with regard to at least FIG. 5.

In some embodiments, an access point (AP) 110 is a wireless communication device that is operable to provide access for other wireless communication devices to a wired network. For example, an AP 110 may include a Wi-Fi networking device that allows Wi-Fi-enabled devices to connect to a wired network using Wi-Fi. In such an embodiment, the AP 110 may act as a bridge between the wired local area network (LAN) and wireless devices, facilitating communication between them. An AP 110 may, for example, be employed in homes, businesses, and public spaces to provide wireless network connectivity. A Wi-Fi type AP 110 may, for example, be equipped with wireless transmitters (TX) and receivers (RX) that use radio frequency signals to communicate with Wi-Fi-enabled devices, such as laptops, smartphones, tablets, and other wireless clients. An AP 110 may have one or more Ethernet ports to connect to a wired network infrastructure, and these ports may be used to establish a connection between the AP 110 and the existing wired network, typically through a router or switch. In some embodiments, a Wi-Fi type AP 110 broadcasts a network name, known as the service set identifier (SSID). Other Wi-Fi-enabled devices may, for example, use the SSID to identify and connect to the AP 110 and the wireless network. The SSID may be user configurable to make the network easily recognizable and distinguish it from other nearby networks. In some embodiments, a Wi-Fi type AP 110 provides, in its transmissions, a basic service set identifier (BSSID) that includes the media access control (MAC) address of the AP 110. The MAC address may be a fixed value (e.g., not user configurable) that uniquely identifies the AP 110. As described, the MAC address of a BSSID for an AP 110 may be used to specifically identify the AP 110 as the source of certain wireless transmissions.

An AP 110 may, for example, support various Wi-Fi standards, such as 802.11n, 802.11ac, 802.11ax (Wi-Fi 6), or the like, which define the specifications for data rates, frequency bands, and other aspects of wireless communication. For example, as described, an AP 110 may be a WiFi6E device, employing Wi-Fi 6E techniques, which are an extension of the Wi-Fi 6 standard into the 6-GHz spectrum that potentially provides relatively faster speeds, lower latency, and more security to the network. An AP 110 may, for example, be a WiFi6E device (6E=6 GHz Extended) wireless devices permitted to operate in the 5925-7125 MHz frequency band under constraints given by the FCC RO 20-51A1. For example, some or all of AP 110a-110e may include WiFi6E enabled Wi-Fi access points. In some embodiments, an AP 110 includes a computer system, which may be the same or similar to computer system 1000 described with regard to at least FIG. 5.

In some embodiments, communication network (“network”) 109 is operable to communicatively couple one or more entities of environment 100. For example, network 109 may operate to communicatively couple some or all of the wireless devices 106, including some or all of the P2P terminal systems 108 (e.g., including one or both of P2P terminal systems 108a and 108b) and the APs 110 (e.g., including some or all of APs 110a-110e) to the coordinator 102. Network 109 may include, for example, one or more electronic communication networks, such as the Internet, a wired or wireless local area network (e.g., a wired Ethernet network or Wi-Fi based network), a wired or wireless wide area network (e.g., a wired Ethernet network or wireless cellular based network), a wired or wireless personal area network (e.g., a wireless Bluetooth based network), or the like that facilitates communication between the various devices/entities communicatively coupled thereto. As described, registration requests 120, transmission characteristics 122, interference reports 124, or the like may be communicated between the coordinator and one or more wireless devices 106 via network 109.

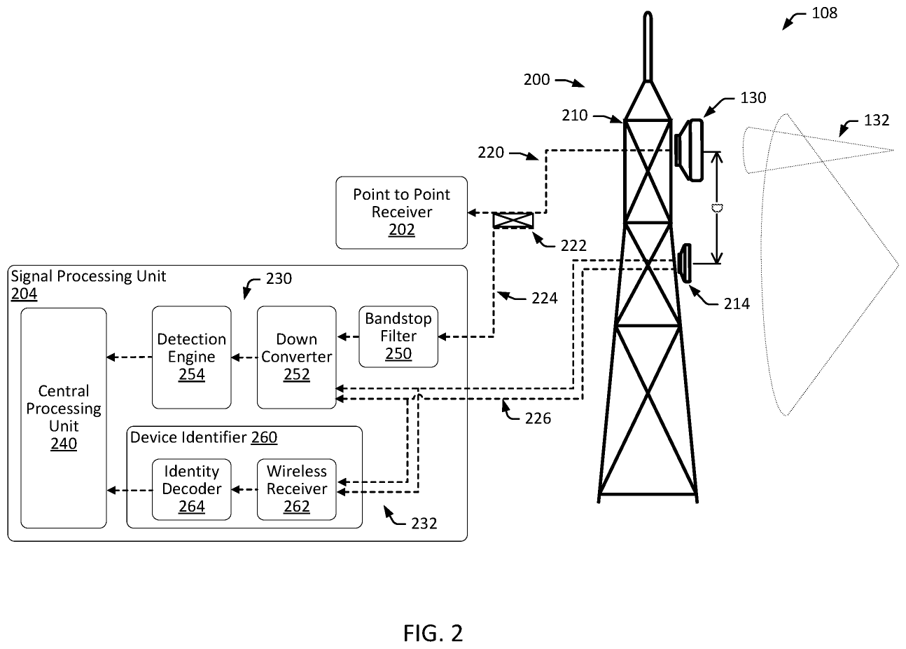

FIG. 2 is a diagram that illustrates a P2P terminal system 108 in accordance with one or more embodiments. In the illustrated embodiment, the P2P terminal system 108 includes a point-to-point (P2P) antenna system 200, a point-to-point (P2P) receiver 202 and a point-to-point (P2P) terminal signal processing unit (or “SPU”) 204.

The P2P antenna system 200 includes a point-to-point (P2P) antenna structure (or “tower”) 210, a point-to-point (P2P) antenna 130 and a wireless antenna 214 communicatively coupled to P2P receiver 202 and SPU 204. The P2P antenna 130 may, for example, be coupled to the P2P receiver 202 by way of coaxial cable (or “coax”) 220 that directs RF signals received by the P2P antenna 130 (e.g., “P2P” RF signals) to an input of the P2P receiver 202. The P2P antenna 130 may, for example, be coupled to the SPU 204 by way of coax 220, a coupler 222 and a second coax 224. The coupler 222 may be a coaxial directional coupler (e.g., including a passive RF (radio frequency) device used to split or combine RF signals) operable to sample at least a portion of the RF signals received by the P2P antenna 130 (e.g., sample “P2P” RF signals traveling on the coax 220) and provide a corresponding signal on second coax 224, which is directed to an input of SPU 204 (e.g., to an input of a bandstop filter of the SPU 204). Such a coupler 222 may, in effect, provide the P2P RF signals received at the P2P antenna 130, to the SPU 204 for processing. The wireless antenna 214 may, for example, be coupled to the SPU 204 by way of set of coaxial cables 226 (e.g., a double (or “twin”) coaxial cable) that directs RF signals received by the wireless antenna 214 (e.g., “wireless” RF signals) to an input of SPU 204 (e.g., to an input of a down converter or Wi-Fi Receiver of the SPU 204).

As described with regard to at least FIG. 1, in some embodiments, P2P antenna 130 is a directional antenna. In some embodiments, wireless antenna 214 is a wide beamwidth antenna (e.g., an omnidirectional antenna). Such a wide beamwidth antenna may be designed to operate over a broad range of radio frequencies, covering a wide portion of the electromagnetic spectrum. In some embodiments, wireless antenna 214 has relatively low directional characteristics, making it relatively sensitive for sensing signals emanating from a variety of directions. For example, wireless antenna 214 may be a dual-polarized Wireless Local Area Network (WLAN) receiving antenna that is operable to receive RF signals in a WLAN using dual polarization. Dual polarization may refer to the antenna supporting both horizontal and vertical polarizations simultaneously, which may enable the antenna to receive signals with different polarization orientations, enhancing its ability to capture diverse signal paths.

In some embodiments, P2P antenna 130 and wireless antenna 214 are physically separated by a distance (D) (e.g., 1 meter (m), 5 m, 10 m, or the like) that is sufficient to reduce or minimize receipt of P2P transmit (TX) RF signals by wireless antenna 214 while enabling P2P antenna 130 to receive both of (relatively narrow) P2P RF signals and (relatively wide) wireless RF signals. The distance (D) may be defined by a distance between focal points of the antennas 120 and 214. As described, such differentiations between the received signals may enable comparisons of received signals that can be used to identify and resolve interference caused by wireless RF signals.

In some embodiments, P2P receiver 202 is operable to receive and process P2P signals. For example, P2P receiver 202 may decode and digitize P2P signals received via P2P antenna 130 and coax 220 and provide the resulting data to an intended recipient, such as another network device that is employed to transmit the data to a computer system or other intended recipient. In some embodiments, P2P receiver 202 is accompanied by a P2P transmitter device to provide for both transmission and receipt of signals. For example, P2P receiver 202 may be a receiver device of a transceiver device, where the receiver and a transmitter of the transceiver are coupled to the P2P antenna 130 through a duplexer.

In some embodiments, SPU 204 is operable to identify and report interfering APs 110 to coordinator 102. For example, SPU 204 may assess one or both of P2P signals and wireless signals to determine the identity of one or more interfering APs 110 and send, to the coordinator 102, an interference report 124 that identifies the one or more interfering APs 110. In some embodiments, the SPU 204 employs a first signal processing path (or “first path”) 230 that is operable to assess P2P signals and wireless signals to determine times of signal interference (e.g., interference of the wireless signal with the P2P signal), employs a second signal processing path (or “second path”) 232 that is operable to determine times and identities for one or more AP devices 110 transmissions, and employs a central processing unit (CPU) 240 that is operable to correlate a time of signal interference (e.g., indicated by an output of first path 230) with a corresponding time of transmission by an AP device 110 (e.g., indicated by an output of the second path 232) to identify an offending AP device 110 (e.g., an AP device 110 determined to be transmitting at the time of interference). As described, CPU 240 may, in turn generate a corresponding interference report 124 that identifies the one or more interfering APs 110, and send that interference report 124 to coordinator 102, which may, in response, effect modification of transmission characteristics for the one or more interfering APs 110 in an effort to reduce or eliminate the interference to the P2P signal.

In some embodiments, first path 230 of SPU 204 includes a bandstop filter 250, a down converter 252 and a detection engine 254, with an output indicative of a time of interference of the P2P signal.

In some embodiments, bandstop filter 250 is operable to attenuate or block a specific range of frequencies while allowing all other frequencies to pass. For example, bandstop filter 250 may be operable to attenuate or block signal frequencies of the (local) P2P TX signal. This may remove strong locally generated P2P transmission signal components that are coupled to the wireless antenna. The output of bandstop filter 250 may be provided to an input of down converter 252.

In some embodiments, down converter 252 is operable to perform frequency down conversion of the incoming signals to generate corresponding down-converted signals. For example, down converter 252 may be a double down converter operable to receive the version of the P2P RX signal output by bandstop filter 250 and shift the frequency of the incoming P2P signal to a lower frequency (e.g., from 0 MHz to 500 MHz) and to receive the two wireless signals via the coax 226 and shift the frequency of the incoming two wireless signals to a lower frequency (e.g. from 0 MHz to 500 MHz). This may make each of the signals more suitable for further processing, amplification, demodulation, detection, correlation or the like. The output of down converter 252 may include down converted versions of the P2P and wireless signals that are provided to an input of detection engine 254.

In some embodiments, detection engine 254 is operable to identify signal interference and a time of the signal interference. For example, detection engine 254 may be operable to digitize the down converted versions of the P2P and wireless signals, calculate (based on the P2P and wireless signals) a signal-to-noise ratio (SNR) of the P2P signal at regular intervals (e.g., every 100 microseconds). The SNR calculation may be based on the decoding of the P2P signal and determining suitable signal quality metric, for example Error Vector Magnitude (EVM), and by observing Forward Error Correction (FEC) quality metric, for example number of corrected data blocks. The time correlation between the detected P2P signal SNR drops and recovers and detected wireless devices signals may be obtained by, for example, first removing the modulated P2P signal content from the P2P received signal via 224 by self-interference (SiC) processing and then correlating the remaining signal (e.g., which now contains noise, distortion and interference signals) with wireless signals received via 226. The interference threshold may be configurable and may depend on the deployed P2P link quality metrics (e.g., modulation order and fade margin). The output of detection engine 254 may include an indication of one or more times of interference with corresponding SNR level of the P2P signal that is provided to CPU 240.

In some embodiments, second path 232 of SPU 204 includes a device identifier 260 that is operable to provide an indication of what wireless devices 106 are transmitting and when. This may include, for a given transmission by a wireless device 106 (e.g., by an AP 110) captured by the wireless antenna 214 and present in the wireless signals, a time of the given communication (e.g., an interval, start time, duration, or stop time) and an identity (e.g., a BSSID or MAC address) of a wireless device 110 determined to transmit the communication. In such an embodiment, device identifier 260 may be referred to as a “BSSID” identifier or “MAC” identifier.

In some embodiments, device identifier 260 includes a wireless receiver 262 and an identity decoder 264. In some embodiments, wireless receiver 262 is a device operable to receive and identify components of the wireless signals. For example, receiver 262 may be a Wi-Fi receiver or a network analyzer (e.g., a “Wi-Fi sniffer”), that is operable to detect and demodulate Wi-Fi RF transmission frames, on the wireless signal input. The output of receiver 262 may include Wi-Fi frames contained in the wireless signals that are provided to an input of identity decoder 264.

In some embodiments, identity decoder 264 is a device operable to determine, from the output of receiver 262, times of given communications (e.g., start time, duration, or stop time) and an identity (e.g., a BSSID or MAC address) of a wireless device 106 (e.g., an AP 110) determined to transmit the communication. For example, identity decoder 264 may be a BSSID decoder that is operable to inspect demodulated Wi-Fi frames (provided by receiver 262), and extract, for each frame, a corresponding time of transmission and an identity (e.g., BSSID or MAC address) associated with the Wi-Fi frame. The output of identity decoder 264 may include an identifier mapping (e.g., a BSSID mapping) including indications of times of transmissions (e.g., times of transmissions of Wi-Fi frames) and for each of the transmissions, an identity (e.g., BSSID or MAC address) of wireless device 106 (e.g., an AP 110) determined to have generated the transmission.

In some embodiments, CPU 240 is operable to correlate a time of signal interference indicated by output of detection engine 254 with a corresponding time of transmission by an AP device 110 indicated by an output of identity decoder 264 to identify an offending wireless device 106 (e.g., an offending AP 110). For example, in response to an output of detection engine 254 indicating a time of interference of the P2P signal received at antenna 130 of terminal system 108a at 1:00:00,00000 pm, CPU 240 may identify, from a BSSID mapping output of identity decoder 264, a transmission that occurred at that time (e.g., Wi-Fi packet transmitted at exactly the same time or shortly before or after that time associated with a BSSID of wireless device AP 110a), and determine the identity (e.g., a BSSID or MAC address, such as 00:1A:2B:3C:4D:5E) as the transmitter (or “source”) of the transmission. In such an embodiment, CPU 240 may send, to coordinator 102, an interference report that indicates interference on the P2P signal of terminal system 108a at 1:00:00,00000 pm by a wireless device associated with MAC address 00:1A:2B:3C:4D:5E. CPU 240 may employ various filtering methods not to overload the 102 with interference reports, for example generating a re-occurring interference report from the same wireless device not earlier than, for example, 1 minute after the first report. As described, coordinator 102 may determine that the MAC address is associated with the MAC address recorded for AP 110a and, in turn, generate an updated set of device transmission characteristics 122 for AP 110a that are intended to reduce or eliminate the interference (e.g., excluding one or more wireless channels that the P2P terminal system 108a is using, or excluding the channel that AP 110a is currently using) and send the updated set of device transmission characteristics to AP 110a.

In some embodiments, device registration of a wireless device 110 includes the wireless device 110 sending its registration information to coordinator 102. Registration of an AP 110 may include the AP sending, to coordinator 102, a registration request 120 including a unique identifier of the AP 110, such as a MAC address of the AP 110, along with other characteristics of the AP 110, such as transmission capabilities or the like. The coordinator 102 may, in response to receiving the registration request 120, determine a set of device transmission characteristics 122 for the AP 110, including one or more RF channels available for transmission by the AP device 110, and send the transmission characteristics 122 to the AP 110 and create, in a device registration record 116 stored on the coordinator database 114, a record for the AP 110 that includes the unique identifier of the AP 110, the transmission characteristics 122, or other characteristics of the AP 110 (e.g., the transmission capabilities of the AP 110). In such an embodiment, the AP device 110 may, in turn, operate according to the set of device transmission characteristics 122, for example, including transmitting on the one or more RF channels indicated. In some embodiments, such a registration operation may be conducted on a regular basis. For example, APs 110 may be required to conduct a registration with coordinator 102 hourly, daily, or the like. In some embodiments, the transmission characteristics 122 include for each channel, a specific set of parameters, such as a frequency range, power level (or “transmission power”), bandwidth, or the like. Registration of a terminal system 108 may include the terminal system 108 sending, to coordinator 102, a registration request 120 including a unique identifier of the terminal system 108, an indication of transmission characteristics of the terminal system 108, such as the channels (and characteristics thereof) used for communication by the terminal system 108, along with other characteristics of the terminal system 108, such as geographic location, antenna height, antenna size and direction, or the like. In some embodiments, the transmission characteristics of a terminal system include one or more channels, and for each channel, a specific set of parameters, such as a TX and RX frequency, power level, bandwidth, modulation, or the like. The coordinator 102 may, in response to receiving the registration request 120 from the terminal system 108, create, in a device registration record 116 stored on the coordinator database 114, a record for the terminal system 108 that includes the unique identifier of the terminal system 108, the transmission characteristics of the terminal system 108, such as the channels used for communication by the terminal system 108, along with other characteristics of the terminal system 108.

As described, the registration information and associated device registration record 116 may be employed to reduce interference. For example, in response to receiving an interference report 124 from terminal system 108a indicating that AP 110a is generating interference of its P2P signal, coordinator 102 may reference device registration record 116 to determine the channels that terminal system 108a is using (e.g., channels 1, 2, and 3) and generate an updated set of channels for use by AP 110a that do not include the channels that terminal system 108a is using (e.g., channels 4, 5, and 6) and generate and send to AP 110a, updated transmission characteristics 122 that do not include use of the channels that terminal system 108a is using (e.g., including only channels 4, 5 and 6). Although excluding channels is provided as an example of modification of transmission characteristics, embodiments may include any suitable modifications to transmission characteristics. For example, coordinator 102 may determine that simply changing the power level for transmission on a given channel may reduce interference and, in turn, send to AP 110a, updated transmission characteristics 122 that include use of the channels that terminal system 108a is using, but at a lower power level.

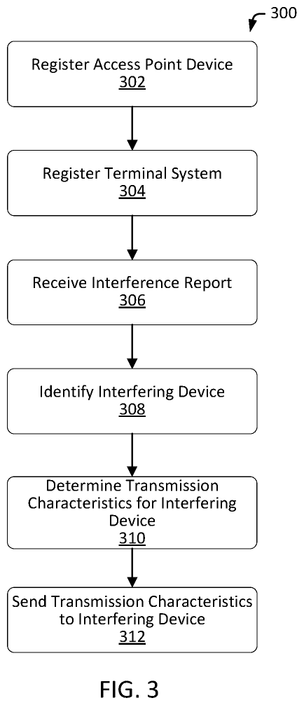

FIG. 3 is a flowchart diagram that illustrates a method 300 of coordinating operations of communication devices in accordance with one or more embodiments. Some or all of the procedural elements of method 300 may be performed, for example, by coordinator 102 or another entity.

In the illustrated embodiment, method 300 includes registering an access point device (block 302). This may include receiving a registration request from an AP, including a unique identifier of the AP, and sending, to the AP, a set of transmission characteristics. For example, registering an access point device may include, in response to coordinator 102 receiving a registration request 120 from AP 110a (e.g., including a unique identifier of AP 110a, such as a MAC address of 00:1A:2B:3C:4D:5E of AP 110a (or other unique hardware address of AP 110a), along with other characteristics of AP 110a, such as transmission capabilities or the like), coordinator 102 determining a set of device transmission characteristics 122 for AP 110a, including one or more RF channels available for transmission by AP device 110a, and sending the transmission characteristics 122 to AP 110a. This may also include coordinator 102, generating, in device registration record 116, a record for AP 110a that includes the unique identifier of AP 110a, the transmission characteristics 122, or other characteristics of AP 110a (e.g., the transmission capabilities of AP 110).

In the illustrated embodiment, method 300 includes registering a terminal system (block 304). This may include receiving a registration request from a terminal system, including an indication of transmission characteristics of the terminal system 108. For example, registering a terminal system may include, in response to coordinator 102 receiving a registration request 120 from terminal system 108a (e.g., including a unique identifier of terminal system 108a, an indication of transmission characteristics of terminal system 108a, such as the channels (and characteristics thereof) used for communication by terminal system 108a, along with other characteristics of the terminal system 108a, such as geographic location, antenna height, or the like), coordinator 102, generating, in device registration record 116, a record for terminal system 108a that includes the unique identifier of terminal system 108a, the transmission characteristics of the terminal system 108a, such as the channels (and characteristics thereof) used for communication by terminal system 108a, or other characteristics of terminal system 108a.

In the illustrated embodiment, method 300 includes receiving an interference report (block 306). This may include receiving an interference report indicating that a particular wireless device is creating interference. For example, receiving an interference report may include coordinator 102 receiving, from terminal system 108a, an interference report 124 indicating that a wireless device having a MAC address of 00:1A:2B:3C:4D:5E is generating interference of its P2P signal.

In the illustrated embodiment, method 300 includes identifying an interfering device (block 308). This may include identifying a particular wireless device corresponding to a wireless device identified in an interference report. For example, identifying an interfering device may include coordinator 102, in response to receiving an interference report 124 indicating that a wireless device having a MAC address of 00:1A:2B:3C:4D:5E is generating interference of a P2P signal of terminal system 108a, identifying AP 110a as an interfering wireless device for terminal system 108a based on AP 110a having the MAC address of 00:1A:2B:3C:4D:5E (e.g., specified in its registration and recorded in device registration record 116).

In the illustrated embodiment, method 300 includes determining transmission characteristics for an interfering device (block 310). This may include determining transmission characteristics for a wireless device that are expected to reduce interference created by the device. For example, determining transmission characteristics for an interfering device may include coordinator 102, in response to identifying AP 110a as an interfering wireless device, identifying AP 110a as an interfering wireless device for terminal system 108a, and determining transmission characteristics for AP 110a that are expected to reduce interference with terminal system 108a. For example, in response to receiving an interference report 124 from terminal system 108a indicating that AP 110a is generating interference of its P2P signal, coordinator 102 may reference device registration record 116 to determine the channels that terminal system 108a uses (e.g., channels 1, 2, and 3) and generate an updated set of channels for use by AP 110a that do not include the channels that terminal system 108a is using (e.g., only channels 4, 5 and 6).

In the illustrated embodiment, method 300 includes sending transmission characteristics to an interfering device (block 312). This may include sending determined transmission characteristics for a wireless device, to the wireless device. For example, sending transmission characteristics to an interfering device may include coordinator 102 sending, to AP 110a (with MAC address 00:1A:2B:3C:4D:5E), updated transmission characteristics 122 that do not include use of the channels that terminal system 108a is using (e.g., only channels 4, 5 and 6). AP 110a may, for example, subsequently transmit in accordance with the updated transmission characteristics 122 (e.g., only on channels 4, 5, and 6).

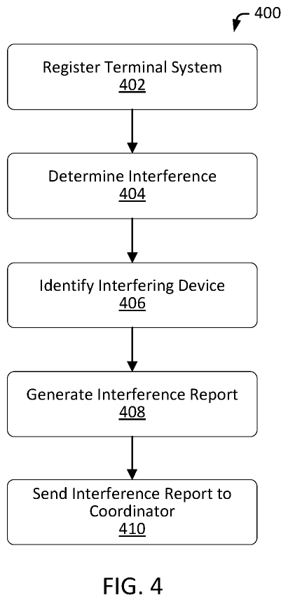

FIG. 4 is a flowchart diagram that illustrates a method 400 of monitoring communications for interference in accordance with one or more embodiments. Some or all of the procedural elements of method 400 may be performed, for example, by one or more entities of terminal system 108 or another entity.

In the illustrated embodiment, method 400 includes registering a terminal system (block 402). This may include receiving a set of transmission characteristics for the terminal system. For example, registering a terminal system may include, in response to coordinator 102 receiving a registration request 120 from terminal system 108a (e.g., including a unique identifier of the terminal system 108, an indication of transmission characteristics of terminal system 108a, such as the channels 1, 2 and 3 (and characteristics thereof) used for communication by terminal system 108a, along with other characteristics of terminal system 108a, such as geographic location, antenna height, or the like), coordinator 102 generating, in device registration record 116, a record for terminal system 108a that includes the unique identifier of the terminal system 108, the transmission characteristics of terminal system 108a, such as the channels 1, 2 and 3 (and characteristics thereof) used for communication by terminal system 108a, along with other characteristics of terminal system 108a.

In the illustrated embodiment, method 400 includes determining interference (block 404). This may include determining that interference is present in a P2P wireless signal and time associated with the interference. For example, determining interference may include, as described with regard to a first path 230 of a SPU 204 of terminal system 108a, the detection engine 254 determining that interference is present in response to determining that a SNR of the P2P signal drops below a specified SNR ratio (e.g., below a threshold of 20 decibels (dB)) at 1:00:00 pm, identifying 1:00:00 pm as a time of interference of the P2P signal for terminal 108a, and outputting an indication thereof to a detection engine 254 the SPU 204 of terminal system 108a.

In the illustrated embodiment, method 400 includes identifying an interfering device (block 406). This may include determining, based on an identifier present in a received wireless signal, an identity of an interfering (or “offending”) wireless device. For example, identifying an interfering device may include, as described with regard to a second path 232 of a SPU 204 of terminal system 108a, the device identifier 260 outputting indications of transmission times and identities of associated wireless devices 106, including an indication that a wireless device having MAC address 00:1A:2B:3C:4D:5E generated a transmission at 1:00:00 pm, and CPU 240 identifying a wireless device having MAC address 00:1A:2B:3C:4D:5E as an interfering device based on it being associated with a transmission at 1:00:00 pm, a time of interference.

In the illustrated embodiment, method 400 includes generating an interference report (block 408). This may include generating a report that indicates indication of an offending wireless device determined to be generating interference. For example, generating an interference report may include CPU 240 generating an interference report 124 that indicates interference on the P2P signal of terminal system 108a at 1:00:00 pm by a wireless device associated with MAC address 00:1A:2B:3C:4D:5E.

In the illustrated embodiment, method 400 includes sending an interference report to a coordinator (block 410). This may include sending a report that indicates indication of an offending wireless device determined to be generating interference, to a coordinating system. For example, CPU 240 sending an interference report 124 that indicates interference on the P2P signal of terminal system 108a at 1:00:00 pm by a wireless device associated with MAC address 00:1A:2B:3C:4D:5E. As described, such an interference report 124 may, for example, be used as a basis for determining and employing an updated set of transmission characteristics of AP 110a (e.g., associated with MAC address 00:1A:2B:3C:4D:5E) to alleviate the interference of the P2P signal of terminal system 108a. Thus, a terminal system 108 may be capable of reporting on interference to cause actions to resolve the interference.

FIG. 5 is a diagram that illustrates an example computer system (or “system”) 1000 in accordance with one or more embodiments. The system 1000 may include a memory 1004, a processor 1006 and an input/output (I/O) interface 1008. The memory 1004 may include non-volatile memory (e.g., flash memory, read-only memory (ROM), programmable read-only memory (PROM), erasable programmable read-only memory (EPROM), electrically erasable programmable read-only memory (EEPROM)), volatile memory (e.g., random access memory (RAM), static random-access memory (SRAM), synchronous dynamic RAM (SDRAM)), or bulk storage memory (e.g., CD-ROM or DVD-ROM, hard drives). The memory 1004 may include a non-transitory computer-readable storage medium having program instructions 1010 stored on the medium. The program instructions 1010 may include program modules 1012 that are executable by a computer processor (e.g., the processor 1006) to cause the functional operations described, such as those described with regard to one or more of the entities described (e.g., coordinator 102, terminal system 108, APs 110, receiver 202, SPU 204,), or one or more of the operations described (e.g., method 300 or method 400).

The processor 1006 may be any suitable processor capable of executing program instructions. The processor 1006 may include one or more processors that carry out program instructions (e.g., the program instructions of the program modules 1012) to perform the arithmetical, logical, or input/output operations described. The processor 1006 may include multiple processors that can be grouped into one or more processing cores that each include a group of one or more processors that are used for executing the processing described here, such as the independent parallel processing of partitions (or “sectors”) by different processing cores to generate a simulation of a reservoir. The I/O interface 1008 may provide an interface for communication with one or more I/O devices 1014, such as a joystick, a computer mouse, a keyboard, or a display/touch screen (e.g., an electronic display for displaying a graphical user interface (GUI)). The I/O devices 1014 may include one or more of the user input devices. The I/O devices 1014 may be connected to the I/O interface 1008 by way of a wired connection (e.g., an Industrial Ethernet connection) or a wireless connection (e.g., a Wi-Fi connection). The I/O interface 1008 may provide an interface for communication with one or more external devices 1016, computer systems, servers or electronic communication networks. In some embodiments, the I/O interface 1008 includes an antenna or a transceiver.

Further modifications and alternative embodiments of various aspects of the disclosure will be apparent to those skilled in the art in view of this description. Accordingly, this description is to be construed as illustrative only and is for the purpose of teaching those skilled in the art the general manner of carrying out the embodiments. It is to be understood that the forms of the embodiments shown and described here are to be taken as examples of embodiments. Elements and materials may be substituted for those illustrated and described here, parts and processes may be reversed or omitted, and certain features of the embodiments may be utilized independently, all as would be apparent to one skilled in the art after having the benefit of this description of the embodiments. Changes may be made in the elements described here without departing from the spirit and scope of the embodiments as described in the following claims. Headings used here are for organizational purposes only and are not meant to be used to limit the scope of the description.

It will be appreciated that the processes and methods described here are example embodiments of processes and methods that may be employed in accordance with the techniques described here. The processes and methods may be modified to facilitate variations of their implementation and use. The order of the processes and methods and the operations provided may be changed, and various elements may be added, reordered, combined, omitted, modified, and so forth. Portions of the processes and methods may be implemented in software, hardware, or a combination thereof. Some or all of the portions of the processes and methods may be implemented by one or more of the processors/modules/applications described here.

As used throughout this application, the word “may” is used in a permissive sense (meaning having the potential to), rather than the mandatory sense (meaning must). The words “include,” “including,” and “includes” mean including, but not limited to. As used throughout this application, the singular forms “a,” “an,” and “the” include plural referents unless the content clearly indicates otherwise. Thus, for example, reference to “an element” may include a combination of two or more elements. As used throughout this application, the term “or” is used in an inclusive sense, unless indicated otherwise. That is, a description of an element including A or B may refer to the element including one or both of A and B. As used throughout this application, the phrase “based on” does not limit the associated operation to being solely based on a particular item. Thus, for example, processing “based on” data A may include processing based at least in part on data A and based at least in part on data B, unless the content clearly indicates otherwise. As used throughout this application, the term “from” does not limit the associated operation to being directly from. Thus, for example, receiving an item “from” an entity may include receiving an item directly from the entity or indirectly from the entity (e.g., by way of an intermediary entity). As used throughout this application, the term “to” does not limit the associated operation to being directly to. Thus, for example, transmitting an item “to” an entity may include transmitting an item directly to the entity or indirectly to the entity (e.g., by way of an intermediary entity). Unless specifically stated otherwise, as apparent from the discussion, it is appreciated that throughout this specification discussions utilizing terms such as “processing,” “computing,” “calculating,” “determining,” or the like refer to actions or processes of a specific apparatus, such as a special purpose computer or a similar special purpose electronic processing/computing device. In the context of this specification, a special purpose computer or a similar special purpose electronic processing/computing device is capable of manipulating or transforming signals, typically represented as physical, electronic or magnetic quantities within memories, registers, or other information storage devices, transmission devices, or display devices of the special purpose computer or similar special purpose electronic processing/computing device.

In this patent, to the extent any U.S. patents, U.S. patent applications, or other materials (e.g., articles) have been incorporated by reference, the text of such materials is only incorporated by reference to the extent that no conflict exists between such material and the statements and drawings set forth herein. In the event of such conflict, the text of the present document governs, and terms in this document should not be given a narrower reading in virtue of the way in which those terms are used in other materials incorporated by reference.

What is claimed is:

1. A radio communication system comprising:
a point-to-point terminal system comprising:
an antenna system comprising:
a point-to-point antenna configured to receive point-to-point radio frequency (RF) signals from one or more point-to-point wireless devices; and
a wireless antenna configured to receive wireless RF signals from one or more wireless devices;
a point-to-point receiver configured to process a point-to-point RF signal received by way of the point-to-point antenna; and
a signal processing unit (SPU) configured to:
receive the point-to-point RF signal received by way of the point-to-point antenna;
receive a wireless RF signal received by way of the wireless antenna;
determine, based on the point-to-point RF signal and the wireless RF signal, an identity of a wireless device generating interference to the point-to-point RF signal; and
send, to an automated frequency coordination (AFC) system, an interference report comprising an indication of the identity of the wireless device generating interference to the point-to-point RF signal; and
the AFC system communicatively coupled to the one or more wireless devices and the SPU, the AFC system configured to:
receive, from the wireless device, a registration request comprising a unique identifier of the wireless device;
send, to the wireless device in response to receiving the registration request from the wireless device, a set of device transmission characteristics comprising a set of one or more wireless RF channels available for transmission by the wireless device;
receive, from the SPU, the interference report;
determine whether the identity of a wireless device generating interference to the point-to-point RF signal corresponds to the unique identifier of the wireless device;
determine, in response to determining that the identity of the wireless device generating interference to the point-to-point RF signal corresponds to the unique identifier of the wireless device, an updated set of one or more wireless RF channels available for transmission by the wireless device; and
send, to the wireless device, an updated set of device transmission characteristics comprising the updated set of one or more wireless RF channels available for transmission by the wireless device.

2. The system of claim 1, wherein the updated set of one or more wireless RF channels available for transmission by the wireless device are configured to cause the wireless device to employ wireless transmission on the one or more wireless RF channels available for transmission by the wireless device to reduce interference of the point-to-point RF signal.

3. The system of claim 1, wherein the point-to-point antenna comprises a directional antenna.

4. The system of claim 3, wherein wireless antenna comprises an omnidirectional antenna.

5. The system of claim 1, wherein the wireless device comprises an access point (AP).

6. The system of claim 1, wherein the unique identifier of the wireless device comprises a media access control (MAC) address of the wireless device.

7. The system of claim 1, wherein the identity of the wireless device comprises a basic service set identifier (BSSID) of the wireless device or a media access control (MAC) address of the wireless device.

8. The system of claim 1, wherein the device transmission characteristics comprise frequency, transmission power, or bandwidth available for transmission by the wireless device on the wireless RF channels.

9. The system of claim 1, wherein the AFC system is further configured to:
determine that the wireless signal received by way of the wireless antenna is transmitted on a given wireless RF channel, wherein the updated set of one or more wireless RF channels available for transmission by the wireless device excludes the given wireless RF channel.

10. The system of claim 1, wherein the AFC system is further configured to:
determine that the point-to-point RF signal comprises a given wireless RF channel, wherein the updated set of one or more wireless RF channels available for transmission by the wireless device excludes the given wireless RF channel.

11. The system of claim 1, wherein the SPU comprises:
a first signal path configured to identify signal interference at a given time; and
a second signal path configured to determine an identity of a wireless device transmitting at a time corresponding to the given time,
wherein the identity of the wireless device generating interference to the point-to-point RF signal corresponds to the identity of the wireless device transmitting at a time corresponding to the given time.

12. The system of claim 11,
wherein the first signal path comprises:
a down converter configured to receive the point-to-point RF signal and the wireless RF signal and output a down-converted signal; and
a detection engine configured to receive the down-converted signal and output an interference indicator comprising an identification of signal interference at a given time;
wherein the second signal path comprises:
a BSSID identifier configured to receive the wireless RF signal and output a BSSID mapping identifying wireless devices and associated times of transmission by the wireless devices; and
a central processing unit configured to:
receive the interference indicator and the BSSID mapping;
determine, based on the interference indicator and the BSSID mapping, an identifier associated with a wireless device having a time of transmission that corresponds to the given time; and
send, to the AFC system, an interference report comprising the identifier,
wherein the indication of the identity of the wireless device generating interference to the point-to-point RF signal comprises the identifier, and the interference report comprising an indication of the identity of the wireless device generating interference to the point-to-point RF signal comprises the interference report comprising the identifier.

13. A radio communication system comprising:
a terminal system comprising:
an antenna system comprising:
a first antenna configured to receive wireless signals; and
a second antenna configured to receive wireless signals; and
a signal processing unit (SPU) configured to:
receive a first wireless signal received by way of the first antenna;
receive a second wireless signal received by way of the second antenna;
determine, based on the first wireless signal and the second wireless signal, an identity of an interfering wireless device generating interference to the first wireless signal; and
generate an interference report identifying the interfering wireless device;
a coordination system configured to:
receive, from a wireless device, a registration request identifying the wireless device;
send, to the wireless device in response to receiving the registration request, a first set of device transmission characteristics;
receive the interference report;
determine that the interfering wireless device corresponds to the wireless device;
determine, in response to determining that the interfering wireless device corresponds to the wireless device, a second set of device transmission characteristics configured to reduce interference of the first wireless signal; and
send, to the wireless device, the second set of device transmission characteristics.

14. The system of claim 13, wherein the second set of device transmission characteristics excludes a channel used to transmit the first wireless signal.

15. The system of claim 13, wherein the first antenna comprises a directional antenna.

16. The system of claim 15, wherein the second antenna comprises an omnidirectional antenna.

17. The system of claim 13, wherein the wireless device comprises an access point (AP).

18. The system of claim 13, wherein the wireless device is associated with a unique identifier, the interference report comprises the unique identifier, the registration request comprises the unique identifier, and determining that the interfering wireless device corresponds to the wireless device comprises correlating the unique identifier of the interference report with the unique identifier of the registration request.

19. The system of claim 18, wherein the unique identifier of the wireless device comprises a media access control (MAC) address of the wireless device.

20. A method comprising:
receiving, from a wireless device, a registration request identifying the wireless device;
sending, to the wireless device in response to receiving the registration request, a first set of device transmission characteristics;
receiving, from a terminal system, an interference report identifying an interfering wireless device, wherein the terminal system comprises:
an antenna system comprising:
a first antenna configured to receive wireless signals; and
a second antenna configured to receive wireless signals; and
a signal processing unit (SPU) configured to:
receive a first wireless signal received by way of the first antenna;
receive a second wireless signal received by way of the second antenna;
determine, based on the first wireless signal and the second wireless signal, an identity of an interfering wireless device generating interference to the first wireless signal; and
generate the interference report identifying the interfering wireless device;
determining that the interfering wireless device corresponds to the wireless device;
determining, in response to determining that the interfering wireless device corresponds to the wireless device, a second set of device transmission characteristics configured to reduce interference of the first wireless signal; and
sending, to the wireless device, the second set of device transmission characteristics.

21. A non-transitory computer readable storage medium comprising program instructions stored thereon that are executable by a processor to cause the following operations:
receiving, from a wireless device, a registration request identifying the wireless device;
sending, to the wireless device in response to receiving the registration request, a first set of device transmission characteristics;
receiving, from a terminal system, an interference report identifying an interfering wireless device, wherein the terminal system comprises:
an antenna system comprising:
a first antenna configured to receive wireless signals; and
a second antenna configured to receive wireless signals; and
a signal processing unit (SPU) configured to:
receive a first wireless signal received by way of the first antenna;
receive a second wireless signal received by way of the second antenna;
determine, based on the first wireless signal and the second wireless signal, an identity of an interfering wireless device generating interference to the first wireless signal; and
generate the interference report identifying the interfering wireless device;
determining that the interfering wireless device corresponds to the wireless device;
determining, in response to determining that the interfering wireless device corresponds to the wireless device, a second set of device transmission characteristics configured to reduce interference of the first wireless signal; and
sending, to the wireless device, the second set of device transmission characteristics.
